(19) United States
(12) Patent Application Publication
(10) Pub. No.: US 2025/0320074 A1
(43) Pub. Date: Oct. 16, 2025

(54) SHEET FEEDING DEVICE AND IMAGE FORMING APPARATUS

(71) Applicant: CANON KABUSHIKI KAISHA, Tokyo (JP)

(72) Inventor: WATARU MURATA, Chiba (JP)

(21) Appl. No.: 19/083,903

(22) Filed: Mar. 19, 2025

(30) Foreign Application Priority Data
Apr. 12, 2024 (JP) 2024-064666

(51) Int. Cl. B65H 3/48; B65H 7/04; B65H 7/18; G03G 15/00

(52) U.S. Cl. CPC B65H 3/48; B65H 7/04; B65H 7/18; G03G 15/6511; B65H 2511/416; B65H 2513/512

(57) ABSTRACT

A sheet feeding device includes a supporting portion to support a sheet bundle, a feeder to separate and feed a sheet one by one from the sheet bundle, an air blower to blow air to a side end of the sheet bundle and controller to execute a blowing operation in which the air is blown to the side end of the sheet by the air blower and a feeding operation in which the sheet is fed by the feeder. After execution of the blowing operation. the controller executes the feeding operation in a state of stopping the blowing operation in a case where a predetermined time has not elapsed from completion of the blowing operation, and executes another blowing operation and executes the feeding operation in a stated of stopping the anther blowing operation in a case where the predetermined time has elapsed from the completion of the blowing operation.

### FIELD OF THE INVENTION AND RELATED ART

The present invention relates to a sheet feeding device which feeds a sheet and an image forming apparatus which forms an image on the sheet.

In Japanese Patent Application Laid-Open No. H04-023747, it is disclosed that in order to facilitate feeding a sheet while separating the sheets one by one, a sheet feeding device which reduces close contact between the sheets by blowing air on side surfaces of a sheet bundle with a small blower. In addition, in Japanese Patent Application Laid-Open No. 2023-102814, it is disclosed that after a blowing operation in which air is blown to side surfaces of a sheet bundle is performed, performing a sheet feeding operation in a state in which the blowing operation is stopped. However, even in a case in which the close contact between the sheets is reduced by the blowing of air, as time elapses after completion of the blowing, adsorption force between the sheets may increase. As a result, separation defect of the sheet may occur.

### SUMMARY OF THE INVENTION

An object of the present invention is to provide a sheet feeding device and an image forming apparatus capable of suppressing an occurrence of separation defect of a sheet.

An aspect of the present invention is a sheet feeding device comprising: a supporting portion configured to support a sheet bundle; a feeding means configured to separate and feed a sheet one by one from the sheet bundle; an air blowing portion configured to blow air to a side end of the sheet bundle; a control means configured to execute a blowing operation in which the air is blown to the side end of the sheet by the air blowing portion and a feeding operation in which the sheet is fed by the feeding means, wherein after execution of the blowing operation. the control means executes the feeding operation in a state of stopping the blowing operation in a case in which a predetermined time has not elapsed from completion of the blowing operation, and executes another blowing operation and executes the feeding operation in a state of stopping the another blowing operation in a case in which the predetermined time has elapsed from the completion of the blowing operation.

Further features of the present invention will become apparent from the following description of exemplary embodiments with reference to the attached drawings.

### BRIEF DESCRIPTION OF THE DRAWINGS

FIG. 1 is an outline view of an image forming apparatus according to an Embodiment.

FIG. 2 is a block diagram illustrating a control system of the image forming apparatus according to the Embodiment.

FIG. 3 is a perspective view illustrating a feeding device according to the Embodiment.

FIG. 4 is a cross-sectional view of the feeding device according to the Embodiment.

FIG. 5 is a flow chart illustrating a feeding control method according to the Embodiment.

FIG. 6 is an example of transition of adsorption force between sheets with respect to time, during which the sheets are left in a state of a sheet bundle.

FIG. 7 is an enlarged graph of a part of FIG. 6.

FIG. 8 is a schematic view illustrating a measuring method of the adsorption force between the sheets.

FIG. 9 is a top view of the feeding device according to the Embodiment.

FIG. 10 is a flow chart illustrating a feeding control method according to a Comparative Example.

### DESCRIPTION OF THE EMBODIMENTS

Hereinafter, Embodiments according to the present invention will be described

with reference to the drawings.

### Image Forming Apparatus

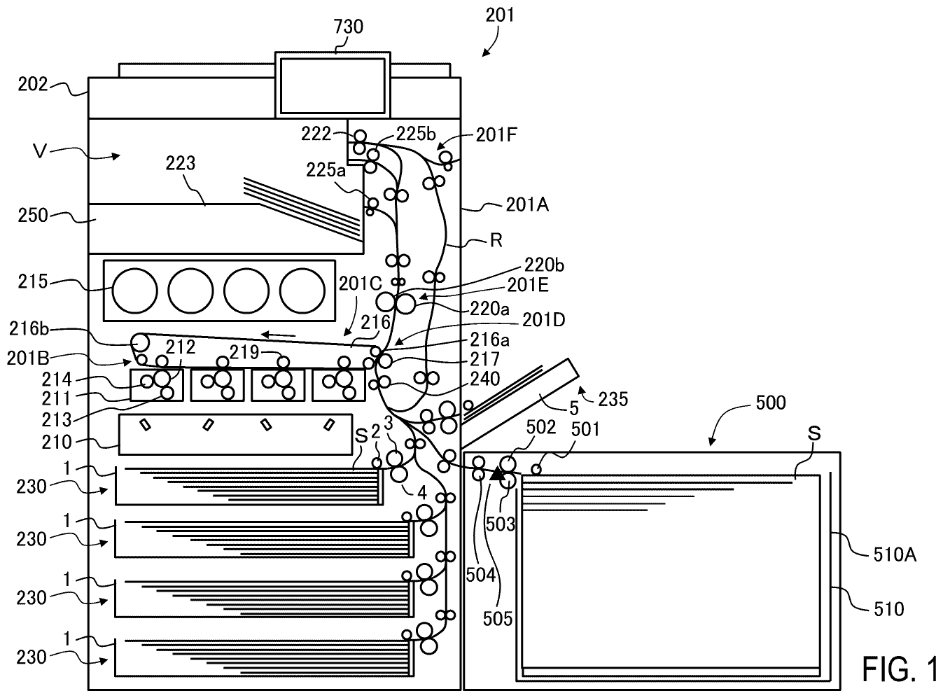

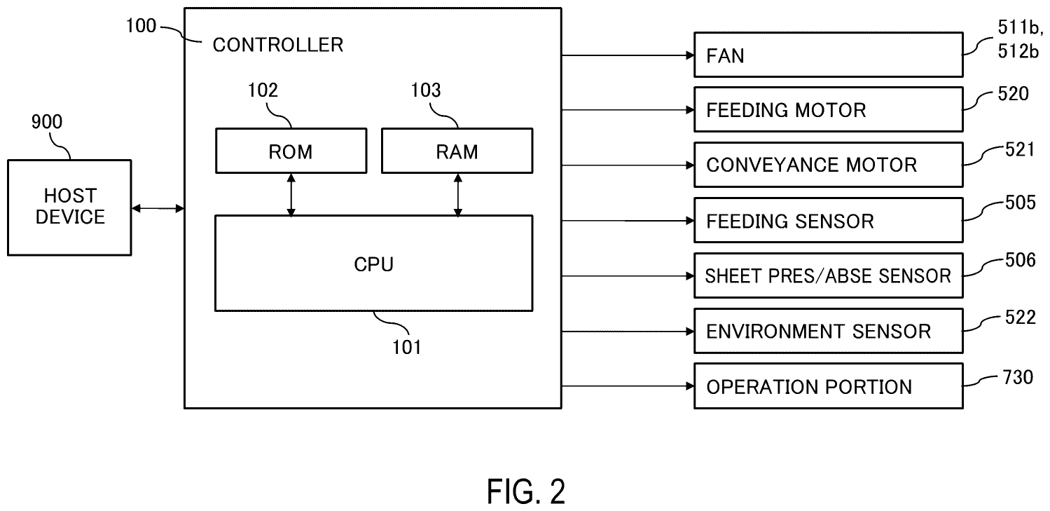

FIG. 1 is an outline view illustrating a cross section of an image forming apparatus 201 according to the Embodiment. The image forming apparatus 201 is a laser beam printer using an electrophotographic process. The image forming apparatus 201 can form (record) a full-color or a single-color image on a sheet S corresponding to image information (printing image data) received from a host device 900 communicably connected to a control portion 100 (FIG. 2). As the sheet S, which is a recording material (recording medium), variety of sheet material of different sizes and material such as, a paper such as a plain paper and a thick paper, sheet material to which a surface treatment is applied such as a coated paper, special shaped sheet material such as an envelope and an index paper, a plastic film and a cloth may be used.

The control portion 100 illustrated in FIG. 2 is a control means which collectively controls operations of the image forming apparatus 201. The control portion 100 performs an exchange of information with the host device 900 and an operating portion 730. In addition, the control portion 100 performs signal processing for various types of process devices, sequence control, etc. Here, the host device 900 is a personal computer, an image scanner, a facsimile, etc.

As illustrated in FIG. 1, the image forming apparatus 201 includes an image forming apparatus main assembly (hereinafter referred to as an apparatus main assembly 201A), an image forming portion 201B and an image reading apparatus 202. The image forming portion 201B is accommodated in the apparatus main assembly 201A. The image reading apparatus 202 is installed approximately horizontally on an upper surface of the apparatus main assembly 201A. In a vertical direction, between the image reading apparatus 202 and the apparatus main assembly 201A, a discharge space V, to which the sheet S on which the image has been formed is discharged, is formed.

In addition, the image forming apparatus 201 is provided with one or more (four in the illustrated example) of cassette feeding portions 230 provided in the apparatus main assembly 201A, a manual feeding portion 235 provided on a side surface of the apparatus main assembly 201A, and an optional feeding device 500 connected to the apparatus main assembly 201A. A configuration of the optional feeding device 500 will be described below.

Each cassette feeding portion 230 includes a cassette 1 (storage) as a sheet accommodating means which accommodates the sheets S, a pickup roller 2 as a feeding member which feeds the sheet S, and a separation conveyance portion (3 and 4) which conveys the sheet S while separating the sheets S. The separation conveyance portion in the present Embodiment includes a feed roller 3 and a retard roller 4, which forms a separating nip together with the feed roller 3. The pickup roller 2, the feed roller 3 and the retard roller 4 function as a feeding unit which feeds the sheets S one by one from the cassette 1.

The manual feeding portion 235 includes a manual feed tray 5 on which a user can manually set the sheet S, and a feeding unit which feeds the sheet S from the manual feed tray 5. The feeding unit may have the same configuration as the feeding unit (2, 3 and 4) in the cassette feeding portion 230.

The image forming portion 201B is an electrophotographic engine of a tandem type and of an intermediary transfer type, and functions as an image forming means which forms the image on the sheet S. The image forming portion 201B includes four process cartridges 211, a laser scanner 210, an intermediary transfer unit 201C, a secondary transfer portion 201D and a fixing portion 201E.

The four process cartridges 211 are process units which form toner images of yellow (Y), magenta (M), cyan (C), and black (K), respectively. Each process cartridge 211 includes a photosensitive drum 212, which is an image bearing member, a charging roller 213 as a charging means, and a developing unit 214 as a developing The developing unit 214 includes a developing roller which carries toner as a 5 means. developer and supplies the toner to the photosensitive drum 212, and a developing container which accommodates the toner. Incidentally, in an upper portion of the apparatus main assembly 201A, toner cartridges 215 as replenishing containers which replenish the toner to the four developing units 214, respectively, are mounted.

The laser scanner 210 as an exposure means includes a laser light source, which emits a laser beam, and an exposure light optical system (polygon mirror, etc.) which directs the laser beam toward a surface of the photosensitive drum 212 in each process cartridge 211. Incidentally, as the exposure means, an LED exposure device, in which light emitting elements (LEDs) are arranged in a rotational axis direction of the photosensitive drum 212 may be used.

The intermediary transfer unit 201C includes an intermediary transfer belt 216, which is an intermediary transfer member, and a plurality of rollers (216a, 216b and 219). The intermediary transfer belt 216 is stretched by a driving roller 216a and a tension roller 216b, and rotated by the driving roller 216a. In addition, at positions on an inner peripheral side of the intermediary transfer belt 216 and opposite to the photosensitive drums 212 across the intermediary transfer belt 216, respectively, four primary transfer rollers 219 are disposed.

The secondary transfer portion 201D is a transfer portion, in which transfer of the toner image to the sheet S is performed, and is a nip portion formed between a secondary transfer roller 217 and the intermediary transfer belt 216. The secondary transfer roller 217 is disposed at a position on an outer peripheral side of the intermediary transfer belt 216 and opposite to the driving roller 216a across the intermediary transfer belt 216.

The fixing portion 201E includes a heating member 220b (fixing member), a heat source which heats the heating member, and a pressing member 220a which forms a fixing nip together with the heating member. The heating member 220b and the pressing member 220a may be any of a roller, a film having a cylindrical shape and a belt stretched by a plurality of rollers. In addition, the heat source may be any of, for example, a halogen lamp which radiates heat, a ceramic heater in which a pattern of a heat generating resistance member is printed on a ceramic substrate, and a coil unit of an induction heating type.

Furthermore, the image forming apparatus 201 includes a first discharging roller pair 225a and a second discharging roller pair 225b and a double-sided reversing portion 201F. The first discharging roller pair 225a and the second discharging roller pair 225b function as a discharging means which can discharge the sheet S, on which the image has been formed by the image forming portion 201B, to the discharge space V, respectively. The double-sided reversing portion 201F includes a reversing roller pair 222, which can reversely rotate, and a reconveyance path R, through which the sheet S reversed by the reversing roller pair 222 is conveyed again toward the image formating portion 201B.

In an upper portion of the image forming apparatus 201, the operating portion 730 as a user interface, which receives operation from the user, is provided. The operating portion 730 includes a display portion such as a liquid crystal panel, which displays information to the user with an image (screen display), and an input portion such as a button and a touch panel, through which the user can input setting information and instruction to the image forming apparatus 201.

### Image Forming Operation

Next, a series of operations (image forming operation), in which the image forming apparatus 201 forms the image on the sheet S while conveying the sheet S one by one, will be described. When the control portion 100 receives an instruction for execution of the image forming operation (print instruction) with an image data, the control portion 100 starts a series of tasks (image forming job, print job), in which the image forming operations are repeatedly executed to a number of sheets S designated by the user. Hereinafter, a flow of the image forming operation for the single sheet S will be described.

In the image forming operation, each photosensitive drum 212 and the intermediary transfer belt 216 are rotationally driven at a predetermined peripheral surface speed (process speed). Each charging roller 213, by charging voltage being applied, uniformly charges the surface of the corresponding photosensitive drum 212 to predetermined polarity and potential. The control portion 100 analyzes the received image data and generates a time series signal (video signal) for driving the laser scanner 210. The laser scanner 210 exposes each photosensitive drum 212 using the laser beam based on the video signal transmitted from the control portion 100. By this, on the surface of each photosensitive drum 212, an electrostatic latent image, which corresponds to a monochromatic image in which the original image data is broken down into each color component, is formed. The developing unit 214 supplies the toner to the photosensitive drum 212 and develops the electrostatic latent image into the toner image. By this, in each process cartridge 211, the toner image, which is the monochromatic image, is formed on the photosensitive drum 212.

The toner images formed on each photosensitive drum 212 are primarily transferred to the intermediary transfer belt 216 by applying voltage to the primary transfer rollers 219. At this time, by the toner images of the four colors being overlapped to each other, a full-color toner image is formed on the intermediary transfer belt 216. The full-color toner image is carried by the intermediary transfer belt 216 and conveyed toward the secondary transfer portion 201D.

In parallel with the formation of the toner image by the image forming portion 201B described above, the sheet S is fed one by one toward the image forming portion 201B from any one of the cassette feeding portion 230, the manual feeding portion 235 and the optional feeding device 500. The fed sheet S is, after an oblique movement correction is applied thereto by a registration roller pair (registration roller pair 240), conveyed to the secondary transfer portion 201D. And in the secondary transfer portion 201D, by applying voltage to the secondary transfer roller 217, the toner image is secondarily transferred from the intermediary transfer belt 216 to the sheet S.

Next, the sheet S on which the toner image has been transferred is conveyed to the fixing portion 201E. The fixing portion 201E fixes the toner image to the sheet S by heating and pressing the toner image on the sheet S while nipping and conveying the sheet S in the fixing nip between the pressing member 220a and the heating member 220b. The sheet S which has passed through the fixing portion 201E is discharged to the discharge space V by the first discharging roller pair 225a or the second discharging roller pair 225b, and is stacked on a stacking portion 223 (discharge tray) provided at a bottom portion of the discharge space V (upper surface portion of the apparatus main assembly 201A). Incidentally, in a case in which the images are formed on both sides of the sheet S, the sheet S of which the image is formed on a first side is reversed by the reversing roller pair 222 and conveyed again to the registration roller pair 240 through the reconveyance path R. And after the image is formed on a second side of the sheet S by passing through the secondary transfer portion 201D and the fixing nip, the sheet S is discharged to the discharge space V by the first discharging roller pair 225a or the second discharging roller pair 225b, and is stacked on the stacking portion 223.

In a case in which the images are formed on a plurality of the sheets S in the single print job, the plurality of sheets S are continuously fed from any one of the cassette feeding portion 230, the manual feeding portion 235 and the optional feeding device 500. And to each sheet S which is continuously fed, the image forming operation described above is executed.

In addition to the image forming operations for the number of sheets designated by the user, the print job includes a preparatory operation before a first image forming operation is performed and an adjusting operation for making the apparatus to be a standby state or a stopped state after the image forming operation is completed. The preparatory operation (also referred to as a pre rotation) prior to the image forming operation includes, for example, cleaning of the photosensitive drums 212 and the intermediary transfer belt 216, preheating of the fixing portion 201E, and adjustment of various types of voltage in the electrophotographic process. The adjusting operation (also referred to as a post rotation) after the image forming operation includes, for example, cleaning of the photosensitive drums 212 and the intermediary transfer belt 216 and a process terminating output of the various types of voltage.

In addition, after the image forming operation for the first sheet S in the print job is started, in a case in which the control portion 100 detects running out or conveyance defect (jam) of the sheet S, the execution of the print job may be interrupted. The running out of the sheet S means that a sheet presence/absence sensor, which detects presence or absence of the sheet S, detects the absence of the sheet in the feeding portion (230, 235, 500), which is selected as a supplying source of the sheet S. In addition, for example, in a case in which one or more sheet sensors, which are disposed along the conveyance path in the image forming apparatus 201, do not detect passing of the sheet S at a scheduled timing, the control portion 100 detects an occurrence of the jam.

The control portion 100, which detects the running out of the sheet S or the occurrence of the conveyance defect (jam), interrupts the image forming operation which is being executed, stops feeding of the next sheet S, and issues a warning to the user via the operating portion 730, etc. Thereafter, when the control portion 100 determines that the print job can be resumed by replenishment of the sheet S or jam clearance being performed, the control portion 100 resumes the print job.

### Optional Feeding Device

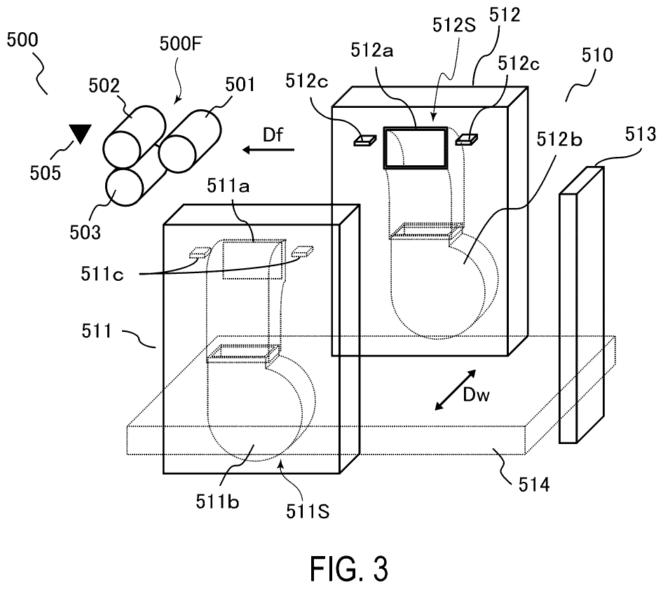

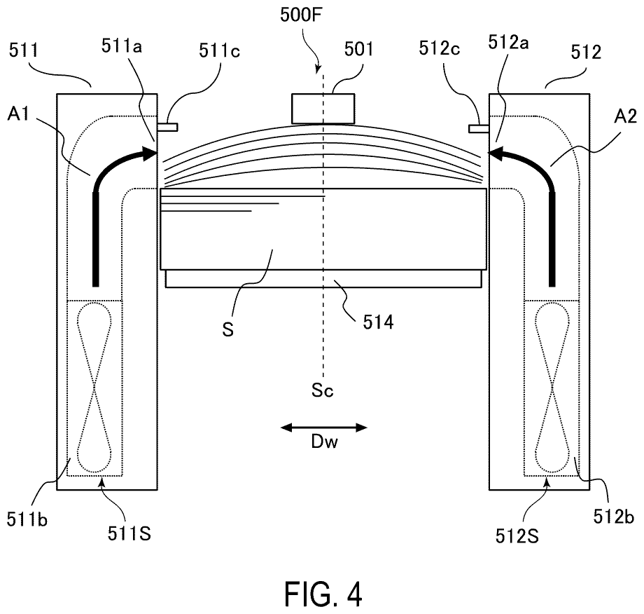

The optional feeding device 500 in the present Embodiment is an example of a sheet feeding device which is provided with an air blowing portion (air loosening mechanism) which loosens the sheet bundle by blowing of air. To “loosen” the sheet bundle means to reduce the close contact between the sheets and facilitate the separation thereof. Hereinafter, the configuration of the optional feeding device 500 will be described, mainly using FIG. 3 and FIG. 4.

FIG. 3 is an outline view illustrating an internal configuration of the optional feeding device 500. FIG. 4 is an outline view illustrating a cross section of the optional feeding device 500 in a plane perpendicular to a sheet feeding direction Df.

As illustrated in FIG. 3 and FIG. 4, the optional feeding device 500 includes a storage 510 (FIG. 1), which accommodates the sheet bundle, a feeding unit 500F as a feeding means which feeds the sheet S, a conveyance roller pair 504 (FIG. 1), and air blowing portions 511S and 512S. The storage 510 and the optional feeding device 500 may be referred to as a feeding deck or a deck feeding device.

The feeding unit 500F includes a pickup roller 501 (first roller) as the feeding member, and a separation conveyance portion (502 and 503). The pickup roller 501 is disposed above a lifter plate 514. The pickup roller 501, by being rotated while being in contact with an upper surface of an uppermost sheet S of the sheet bundle stacked on the lifter plate 514, feeds the uppermost sheet S from the storage 510 toward the sheet feeding direction Df.

The separation conveyance portion in present Embodiment is a roller pair constituted by a feed roller 502 (second roller) and a retard roller 503 (third roller).

The feed roller 502 is disposed downstream of the pickup roller 501 in the sheet feeding direction Df, and conveys the sheet S received from the pickup roller 501 further in the sheet conveyance direction Df. The retard roller 503 is in contact with the feed roller 502 and forms a separating nip together with the feed roller 502. To the retard roller 503, driving force in a direction opposing the sheet feeding direction Df is input via a torque limiter (i.e., the retard roller 503 is retardingly driven).

The storage 510 includes the lifter plate 514, which is capable of being lifted and lowered and on which the sheets S are stacked, regulating members (511, 512 and 513), which regulate positions of the sheet S, and a storage main body 510A (FIG. 1), which supports the lifter plate 514 and the regulating members. The lifter plate 514 is a supporting portion which supports the sheet bundle. The lifter plate 514 is accommodated in the storage main body 510A and is configured to be controllable for lifting and lowering based on a position of an upper surface of the sheet bundle with a lifting/lowering mechanism of wire reel type, for example. The regulating members include a pair of side end regulating plates 511 and 512, which regulate positions of end portions (side ends) of the sheet S in a sheet widthwise direction Dw perpendicular to the sheet feeding direction Df, and a trailing end regulating plate 513, which regulates a position of a trailing end of the sheet S in the sheet feeding direction Df.

The side end regulating plates 511 and 512 are disposed on one side and on the other side with respect to a conveyance center Sc (FIG. 4) in the sheet widthwise direction Dw. The conveyance center Sc is, for example, a central position in the sheet widthwise direction Dw of a contact area in which the pickup roller 501 contacts the sheet S. The side end regulating plates 511 and 512 are connected via an interrelating mechanism such as a rack and pinion, and are configured to move in interrelation with each other so as to maintain a symmetrical positional relationship with respect to the conveyance center Sc. In addition, the trailing end regulating plate 513 is also configured to be adjustable in position according to a length of the sheet S in the sheet feeding direction Df. Incidentally, a position of a leading end of the sheet S in the sheet feeding direction Df is regulated by a wall surface of the storage main body 510A.

The air blowing portion 511S includes a fan 511b, a blowing nozzle 511a and a floating suppressor 511c. Similarly, the air blowing portion 512S includes a fan 512b, a blowing nozzle 512a, and a floating suppressor 512c.

The air blowing portions 511S and 512S in the present Embodiment are disposed so as to blow air toward the side ends of the sheet bundle stacked on the lifter plate 514. In the present Embodiment, the one air blowing portion 511S is incorporated into the one side end regulating plate 511, and the other air blowing portion 512S is incorporated into the other side end regulating plate 512. That is, the fans 511b, 512b, etc., which are elements of the air blowing portions 511S and 512S, move integrally with the side end regulating plates 511 and 512. Incidentally, the air blowing portions 511S and 512S may also be disposed as independent configurations from the side end regulating plates 511 and 512.

The fans 511b and 512b include a blade member which generates an air flow (A1, A2) by being rotated, and a motor portion which rotationally drives the blade member. For the fans 511b and 512b, a sirocco fan which is excellent in quietness may be used, for example, however, other fans such as an axial fan may also be used.

The air blowing nozzles 511a and 512a are opening portions which are provided to regulating surfaces (surfaces opposing to the side ends of the sheet bundle) of the side end regulating plates 511 and 512. The air blowing nozzle 511a is connected to a blowing outlet of the fan 511b through a flow passage, which is formed inside of the side end regulating plate 511. Similarly, the air blowing nozzle 512a is connected to a blowing outlet of the fan 512b through a flow passage, which is formed inside of the side end regulating plate 512.

The floating suppressors 511c and 512c are disposed so as to project to insides from the regulating surfaces of the side end regulating plates 511 and 512 in the sheet widthwise direction Dw (on the conveyance center Sc side). The floating suppressors 511c and 512c have a function to prevent stacking defect caused by the sheets S, which are floated by the blowing of air, getting over the side end regulating plates 511, 512.

In addition, as shown in FIG. 2, the optional feeding device 500 includes the control portion 100, a feeding motor 520, a conveyance motor 521, a feeding sensor 505, a sheet presence/absence sensor 506 and an environment sensor 522.

The control portion 100 functions as a control means which controls operations

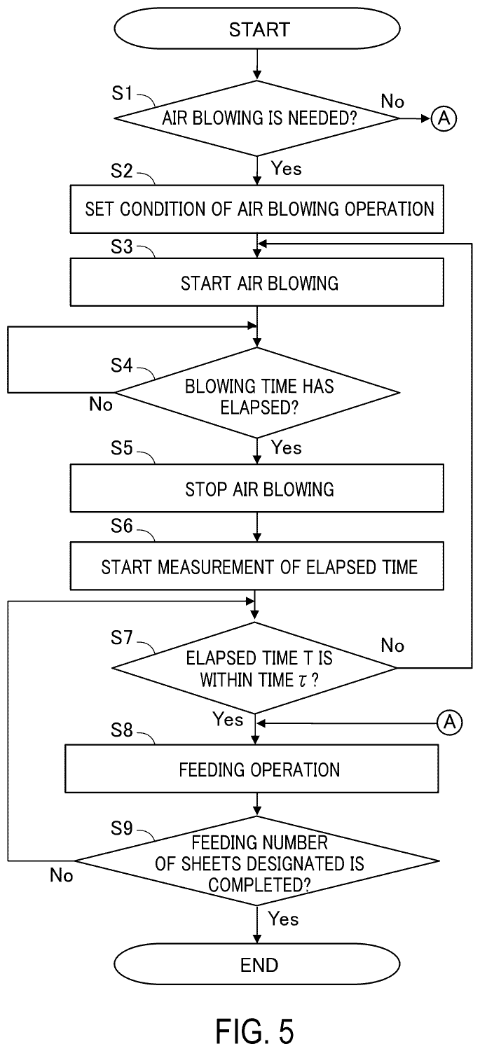

of the optional feeding device 500. The control portion 100 includes a ROM 102 which stores a program, a CPU 101 which reads out and executes the program from the ROM 102, and a RAM 103 which provides a working area for the CPU 101. By the CPU 101 controlling operations of the fans 511b and 512b and each motor (520 and 521) according to the program, the control portion 100 realizes the operations of the optional feeding device 500 according to a flow described below (FIG. 5).

The environment sensor 522 is a detecting means for detecting an environment condition around a space where the optional feeding device 500 or the image forming apparatus 201 is installed. The environment sensor 522 in the present Embodiment can acquire information, as the environment condition, of a temperature (environment temperature) and a relative humidity (environment humidity) around the optional feeding device 500. The control portion 100 can execute control depending on the environment condition based on a detecting result of the environment sensor 522.

The feeding sensor 505 is a sensor which detects the sheet S between the separating nip and the conveyance roller pair 504 (FIG. 1). The control portion 100 can monitor whether or not the feeding of the sheet S is properly performed based on a detecting result of the feeding sensor 505. The sheet presence/absence sensor 506 is a sensor (sheet detecting means) which detects the presence or the absence of the sheet S in the lifter plate 514.

In addition, from a user input via the operating portion 730, for example, the control portion 100 can also acquire information related to an attribute of the sheet S which is set in the storage 510 (hereinafter referred to as “sheet information”). The sheet information may be a combination of one or more selected from a group including a size, a basis weight, presence or absence of a surface treatment, and a brand name of the sheet S.

Incidentally, a part or all of the functions of the control portion 100 described below may be realized by a control circuit which is disposed outside the optional feeding device 500. That is, at least a part of the control portion 100 for controlling the operations of the optional feeding device 500 may be outside the optional feeding device 500. In that case, the “sheet feeding device” is constituted by the optional feeding device 500 and the control circuit for controlling the optional feeding device 500.

### Basic Operation of the Optional Feeding Device

The optional feeding device 500 performs a feeding operation, in which the feeding unit 500F feeds the sheet S while separating the sheets one by one, and an air blowing operation (air loosening operation), in which the air blowing portions 511S and 512S blow air to the sheet bundle to loosen the sheets.

The feeding operation is started by the pickup roller 501 being rotationally driven in the state in which the pickup roller 501 is in contact with the uppermost sheets S on the lifter plate 514. By the rotation of the pickup roller 501, the uppermost sheets S are fed in the sheet feeding direction Df and are further separated into a single sheet in the separating nip. That is, by applying a friction force to the sheet S passing through the separating nip in a direction opposite to the sheet feeding direction Df, the retard roller 503 prevents a plurality of the sheets S from passing through the separating nip (overlapped feeding, double feeding). In addition, in a case in which only the single sheet S passes through the separating nip, the retard roller 503 is rotated following the feed roller 502 and the sheet S due to slippage of the torque limiter. The sheet S, which has passed through the separating nip, is conveyed toward the apparatus main assembly 201A by the conveyance roller pair 504.

The air blowing operation is started by startup of the fans 511b and 512b, and is completed by stop of the fans 511b and 512b. When the fans 511b and 512b are rotated, as shown by current lines A1 and A2 in FIG. 4, air is blown from the blowing nozzles 511a and 512a toward the side ends of the sheet bundle. By air entering spaces between the sheets S, an upward force acts to upper sheets S in the sheet bundle, and an adsorption force between the sheets (close contact between the sheets) is reduced. By the adsorption force between the sheets being reduced, even in a case in which the coated paper, which tends to have the large adsorption force between the sheets, is used, for example, it becomes easier for the feeding unit 500F to convey the sheet S one by one without experiencing the separation defect of the sheet S.

### Control Method

Hereinafter, a control method for the optional feeding device 500 according to the present Embodiment will be described according to a flowchart in FIG. 5. The control portion 100 starts a process of the present flow upon the print job being input, for example. Hereinafter, unless otherwise described in particular, each step in the present flow is executed by the control portion 100 (FIG. 2).

The control portion 100 determines whether or not the air blowing operation (S3 through S5) is executed at a start of the print job (S1). If the air blowing operation is executed, an operating condition for the air blowing operation is set based on the environment condition, etc. detected by the environment sensor 522.

In the present Embodiment, if the sheet S used for the current print job is the coated paper, the environment condition is a high temperature and high humidity environment or a normal environment, and any one of the following conditions is applied, the control portion 100 determines to execute the air blowing operation at the start of the print job (Yes in S1).
a) At the start of the current print job, if a predetermined time τ (described below) has elapsed since a last air blowing operation is executed.
b) If the control portion 100 determines that replenishment of the sheet to the storage 510 is performed or may be performed from completion of the last print job until the start of the current print job.

On the other hand, if the sheet S used for the current print job is other than the coated paper (for example, the plain paper), or if the environment condition is a low temperature and low humidity environment, then the control portion 100 determines not to execute the air blowing operation at the start of the print job (No in S1). In addition, even if the coated paper is used and the environmental condition is met, if neither a) nor b) above are applied, the control portion 100 determines not to execute the air blowing operation at the start of the print job (No in S1).

Incidentally, the described above is only an exemplification of a determining method. The control portion 100 may be configured that if it is determined that the sheets contact closely (the adsorption force between the sheets is relatively strong), then the air blowing operation is executed, and if it is determined that the sheets do not contact closely (the adsorption force between the sheets is relatively week), then the air blowing operation is not executed. For example, in addition to a) and b) above, if the supplying source of the sheet S in the last print job is other than the optional feeding device 500 and the supplying source of the sheet S in the current print job is the optional feeding device 500, then the air blowing operation may be executed.

The operating condition for the air blowing operation includes, in the present Embodiment, a number of rotations of the fans 511b and 512b, which corresponds to an blowing volume of air, and a length of time to rotate the fans 511b and 512b (referred to as a blowing time). In Table 1 below, classifications of the environment condition, representative values for the temperature and the humidity, and set values for the number of rotations of the fans 511b and 512b and the blowing time in the present Embodiment are shown. The number of rotations of the fans 511b and 512b is expressed as duty in PWM control for controlling input electric power to the fans 511b and 512b.

TABLE 1

| | Representative | | |
|---|---|---|---|
| Environment | temperature and | Fan rotation | |
| classifications | humidity | number | Blowing time |
| High | 30° C./80% RH | 80% Duty | 30 seconds |
| temperature and | | | |
| high humidity | | | |
| environment | | | |
| Normal | 23° C./50% RH | 40% Duty | 10 seconds |
| environment | | | |
| Low temperature | 15° C./10% RH | 0% | 0 sec |
| and low | | (No blowing) | (No blowing) |
| humidity | | | |
| environment | | | |

As shown in Table 1 above, in the high temperature and high humidity environment, the blowing volume of air is increased and the blowing time is lengthened compared to the normal environment. In other words, the control portion 100 increases an intensity of the air blowing operation as an absolute moisture content in air around the optional feeding device 500 is high. That is, the blowing volume of air in a case in which the absolute moisture content is a first content (for example, a content corresponding to 30° C./80% RH) is greater than the blowing volume of air in a case in which the absolute moisture content is a second content (for example, the content corresponding to 23° C./50% RH) less than the first content. In addition, the blowing time in the case in which the absolute moisture content is the first content is longer than the blowing time in the case in which the absolute moisture content is the second content less than the first content.

Incidentally, in the present Embodiment, it is defined that an environment of high temperature and low humidity (for example, 30° C./10% RH) is classified as the low temperature and low humidity environment, and an environment of low temperature and high humidity (for example, 15° C./80% RH) is classified as the normal environment.

Based on the above settings, the control portion 100 starts up the fans 511b and 512b and starts the air blowing operation in S3. By this, as shown in FIG. 4, several to several dozens of the sheets S in the upper portion of the sheet bundle on the lifter plate 514 are floated, and the adsorption force between the sheets is reduced. In addition, by the floating suppressors 511c and 512c, it is restricted that the sheets S, which are floated by air, get over the side end regulating plates 511, 512. If the blowing time set in S2 elapses from the startup of the fans 511b and 512b (Yes in S4), then the control portion 100 stops the fans 511b and 512b and completes the air blowing operation (S5).

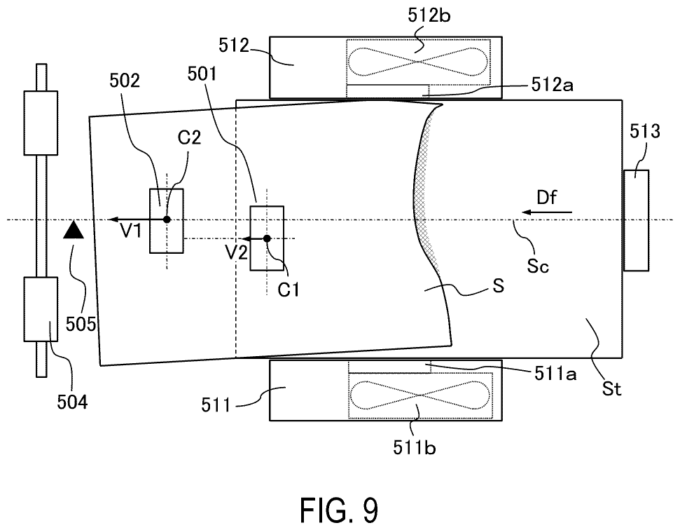

It will be described that by executing the air blowing operation at the start of the print job and executing the feeding operation after the completion of the air blowing operation (S8), it becomes possible to reduce a possibility that oblique movement of the sheet S occurs due to effect of air. For example, as shown in FIG. 9, when the feeding operation is started in parallel with the air blowing operation, flex is generated in the sheet S as the sheet S is floated, and when the side ends of the sheet S leave the side end restricting plates 511 and 512, oblique movement suppressing effect by the side end restricting plates 511 and 512 is reduced. In addition, for assembly tolerances or design reasons, contact positions C1 and C2 (points of action of contact load to the sheet S) of the pickup roller 501 and of the feed roller 502 in the sheet widthwise direction Dw may be misaligned. In such a case, if a difference in conveyance speeds V1 and V2 (V1 >V2) is generated between the pickup roller 501 and the feed roller 502 due to resistance, which the sheet S receives from a conveyance guide, etc., for example, force to turn the sheet S counterclockwise in the figure is generated. In addition, by the contact positions C1 and C2 of the rollers being misaligned from the conveyance center Sc, the turning force may be generated. In contrast, in the present Embodiment, since the feeding operation is executed in the state in which the air blowing operation is stopped (S8), it becomes possible to suppress the oblique movement of the sheet S.

The control portion 100 starts counting of an elapsed time T at the same time as the fans 511b and 512b are stopped (S6). The elapsed time T represents a length of time elapsed without the air blowing operation being executed since the completion of the last air blowing operation.

As the elapsed time T gets longer, air exits from under the sheets S, which are floated by the last air blowing operation. Although the adsorption force between the sheets gradually gets stronger as air exits, unless otherwise the adsorption force exceeds separation capacity of the feeding unit 500F, the feeding unit 500F can feed the sheet S while separating the sheets one by one. However, if the adsorption force gets stronger to such a degree exceeding the separation capacity of the feeding unit 500F, the separation defect may occur.

If the elapsed time T from the completion of the last air blowing operation is the predetermined time τ or less (Yes in S7), the control portion 100 starts a next feeding operation (S8). The start of the feeding operation means that the pickup roller 501 is rotated by the driving force of the feeding motor 520 in the state in which the pickup roller 501 is in contact with the uppermost sheet S. After the start of the feeding operation, as described above, the separation of the sheets S in the separating nip and conveyance of the sheet S by the conveyance roller pair 504 are executed. In addition, a value of the predetermined time τ is stored in the ROM 102 as a set value which is set in advance, for example, and is read out by the CPU 101.

Until the number of sheets S designated by the user upon the input of the print job is fed (No in S9), the control portion 100 returns the process to S7 and repeats the same process. In other words, until the predetermined time τ elapses from the completion of the last air blowing portion (Yes in S7), the control portion 100 repeatedly executes the feeding operation (S8) until the designated number of sheets S are fed. If the feeding of the designated number of sheets S is completed before the predetermined time τ elapses from the completion of the last air blowing operation (Yes in S9), then the control portion 100 completes the process of the present flow.

On the other hand, if the elapsed time T from the completion of the last air blowing operation exceeds the predetermined time τ in S7 (No in S7), then the control portion 100 returns the process to S3 without executing the next feeding operation and executes the air blowing operation (S3 through S5) again. By this, several to several dozens of the sheets S in the upper portion of the sheet bundle on the lifter plate 514 are floated, and the adsorption force between the sheets is reduced again. When the blowing operation is completed, the control portion 100 resets the elapsed time T and starts a new counting.

In this manner, in the case in which the control portion 100 executes the job to feed the designated number of sheets, the control portion 100 (1) repeats the feeding operation until the predetermined time τ elapsed from the completion of the last blowing operation, and (2) repeats that, when the predetermined time τ elapses from the completion of the last blowing operation, stops the feeding operation and executes the blowing operation again until the feeding of the designated number of sheets is completed. In this manner, by executing the air blowing operation at the intervals of the predetermined time τ, it becomes possible to suppress the separation defect of the sheet S.

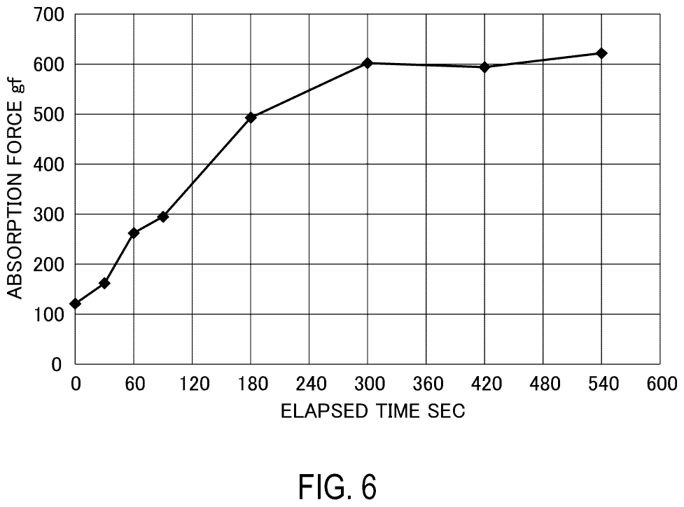

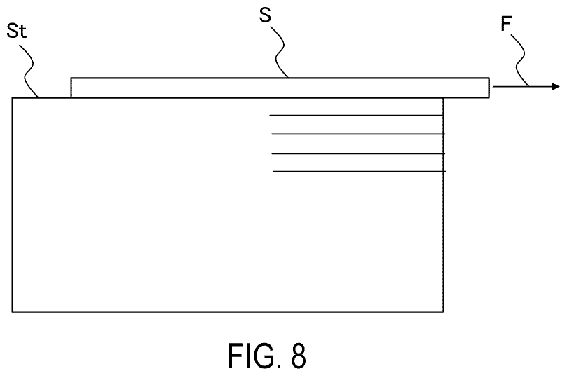

Here, an example of transition of the adsorption force between the sheets with respect to a time, during which the sheets are left in a state of the sheet bundle after once the adsorption force between the sheets is reduced, is shown in FIG. 6. In measurement of the adsorption force, the adsorption force is represented by force F (unit: gf) in the sheet feeding direction Df, which is required to move the uppermost sheet S in a sheet bundle St in the sheet feeding direction Df so as to peel off the uppermost sheet S from the lower sheet, as shown in FIG. 8. The measurements in FIG. 6 are conducted at a temperature of 30° C. and a humidity of 80% RH, which correspond to the high temperature and high humidity environment described above. A horizontal axis in FIG. 6 represents the elapsed time from a start of the leaving, in which the coated papers having the basis weight of 200 g/m² are pulled apart one by one, stacked to be the state of the sheet bundle St, and left. A vertical axis in FIG. 6 represents magnitude of the adsorption force measured by the method in FIG. 8 upon the elapsed time being times set in advance.

As shown in FIG. 6, the adsorption force between the sheets increases monotonically from the start of the leaving until a time of about 300 seconds elapses, and becomes approximately constant magnitude after that. Therefore, when the adsorption force between the sheets, which gets stronger along the elapsed time T after the completion of a most recent air blowing operation, exceeds the separation capacity (separation limit adsorption force) of the feeding unit 500F, the separation defect of the sheet S may occur in the feeding operation. The separation limit adsorption force is a maximum value of the adsorption force between the uppermost sheet S and the lower sheet S, at which the feeding unit 500F can separate the uppermost sheet S from the lower sheet S and feed the uppermost sheet S. In other words, the separation limit adsorption force is the maximum value of the adsorption force which is allowable in the feeding operation. The separation limit adsorption force may vary depending on allowable torque of the torque limiter set in the retard roller 503, friction coefficient between the sheets, respective friction coefficient between the feed roller 502 and the retard roller 503 and the sheet S, etc.

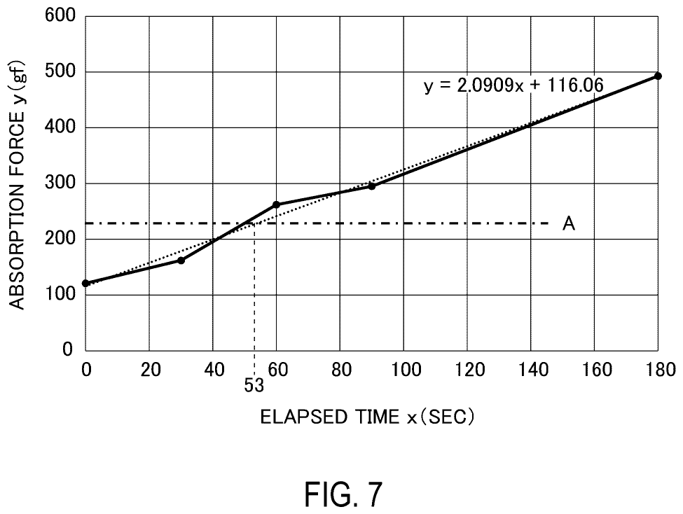

FIG. 7 is a graph in which a section from 0 to 180 seconds, which can be regarded as a section in which the adsorption force monotonically increases in FIG. 6, is extracted. A dash-dotted line A in FIG. 7 shows an example of the separation limit adsorption force. In the present Embodiment, the separation limit adsorption force is set to 228 gf.

By applying a linear approximation to the graph in FIG. 7, relationship between the adsorption force (y) and the elapsed time (x) can be expressed by the following equation (1).

$$y = 2.0909 x + 116.06 \qquad ( 1 )$$

From the above equation (1), in the present Embodiment, it can be seen that the adsorption force between the sheets exceeds the separation limit adsorption force at about 53 seconds from the start of the leaving. In other words, in a case in which the print job is executed with the same coated paper and the environment conditions as in the above test, even if the air blowing operation is executed at the start of the job, the separation defect of the sheet S may occur in the feeding operation after the elapsed time T exceeds 53 seconds after the completion of the air blowing operation.

Thus, in the present Embodiment, the predetermined time τ is set in advance, which is shorter than the value of the elapsed time at which the adsorption force between the sheets reaches the separation limit adsorption force. And when the elapsed time T from the completion of the last air blowing operation exceeds the predetermined time τ, the feeding operation is interrupted, the air blowing operation is executed (No in S7, then S3 through S5), and the feeding operation (S8) is resumed after the completion of the air blowing operation.

In other words, the control portion 100, after executing the blowing operation, if the predetermined time τ has not elapsed since the completion of the last blowing operation, executes the feeding portion in the state in which the blowing operation is stopped. In addition, if the predetermined time τ has elapsed since the completion of the last blowing operation, the control portion 100 stops the feeding operation, executes the blowing operation again, and resumes the feeding operation after the completion of the blowing operation again. By this, since the feeding operation is performed in the state in which the adsorption force between the sheets does not exceed the separation limit adsorption force, it becomes possible to suppress the separation defect of the sheet S.

In other words, according to the present Embodiment, the object to provide the sheet feeding device and the image forming apparatus capable of suppressing the occurrence of the separation defect of the sheet is achieved.

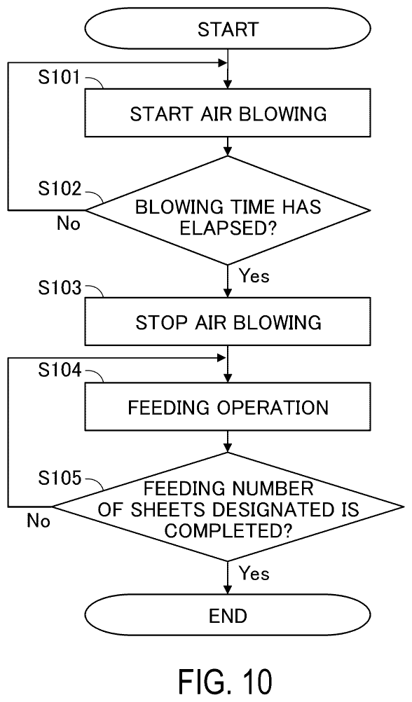

A control method for the optional feeding device 500 in a Comparative Example with respect to the present Embodiment is shown in FIG. 10. In the present Comparative Example, after the air blowing operation is performed at the start of the print job (S101 through S103), the feeding operation is repeated in a state in which the air blowing operation is stopped (S104, S105). In the present Comparative Example, the air blowing operation is not executed again even if the elapsed time after the completion of the air blowing operation gets longer.

According to the present Comparative Example, since the feeding operation is executed in the state in which the air blowing operation is stopped, it is possible to reduce the occurrence of the oblique movement due to the effect of air as in the present Embodiment. However, in the present Comparative Example, even after the elapsed time after the completion of the air blowing operation exceeds the predetermined time τ, the feeding operation (S104) is repeated until a number of sheets S designated by the job is fed. Therefore, the feeding operations are performed in the state in which the adsorption force between the sheets exceeds the separation limit adsorption force, and as a result, the separation defect of the sheet S may occur.

In contrast, according to the present Embodiment, the feeding operation is interrupted before the adsorption force between the sheets exceeds the separation limit adsorption force, and the feeding operation is resumed after the air blowing operation is executed. As a result, it becomes possible to reduce the occurrence of the oblique movement due to the effect of air and to reduce the possibility that the separation defect of the sheet S occurs.

In addition, according to the present Embodiment, regardless of the number of sheets fed by the feeding unit 500F since the completion of the last blowing operation, the blowing operation is executed again based on the fact that the elapsed time T from the completion of the last blowing operation exceeds the predetermined time τ. In other words, assuming that, in a case in which the print job is interrupted for some reasons and then resumed, the elapsed time from the completion of the last blowing operation, which has been executed before the interruption of the job, until the resumption of the job exceeds the predetermined time τ. In this case, even if the number of fed sheets from the completion of the last blowing operation to the interruption of the job is small, when the job is resumed, the feeding of the sheet S is resumed after the blowing operation is executed.

Therefore, even if the adsorption force between the sheets exceeds the separation limit adsorption force during the interrupted period of the print job, when the print job is resumed, the feeding of the sheet S is resumed in the state in which the adsorption force is reduced by the blowing operation. Therefore, it becomes possible to execute the blowing operation at a more appropriate timing compared to a configuration in which an executing timing of the blowing operation is determined based on the number of fed sheets, for example. Incidentally, the reasons why the print job is interrupted include the conveyance defect (jam), running out of the toner, the running out of the sheet S, and an instruction for interruption from the user, etc.

In addition, in S1 in the flow in FIG. 5, according to a) described above, if the elapsed time from when the air blowing operation is executed in the last job until the start of the current job does not exceed the predetermined time τ, then the feeding operation is started without executing the air blowing operation at the start of the current job. In other words, in a case in which a second job is executed after a first job, when the elapsed time from the completion of the last blowing operation which has been executed during execution of the first job until the start of the second job does not exceed the predetermined time, the control portion 100 starts the feeding operation without executing the blowing operation at starting the second job. As such, in the case in which the loosening effect of the air blowing operation in the last print job still remains, by starting the feeding of the sheet S in the current print job without executing the blowing operation, it becomes possible to improve productivity of the optional feeding device 500.

Incidentally, the control may be simplified and it may be configured that at the start of the print job, the air blowing operation is always executed and then the feeding operation is started. In addition, for example, it may be configured that only in a case in which the environment conditions are changed between at the start of the last print job and at the start of the current print job, the air blowing operation is executed at the start of the current print job.

In the determination of the necessity of the air blowing operation (S1) in the flow in FIG. 5, according to b) described above, if the replenishment of the sheet S is performed, even if the elapsed time T does not exceed the predetermined time, the air blowing operation is executed. In other words, in a case in which the sheet presence/absence sensor 506 (sheet detecting means) detects the presence of the sheet in the lifter plate 514 (supporting portion) after the sheet presence/absence sensor 506 has detected the absence of the sheet in the lifter plate 514 (supporting portion), the control portion 100 starts the feeding operation after executing the air blowing operation even if the predetermined time τ has not elapsed from the completion of the last blowing operation. Since the sheet bundle which is newly stacked on the lifter plate 514 may be in a state in which the adsorption force between the sheets is strong, by executing the above control, it becomes possible to suppress the separation defect in the feeding operation after the replenishment of the sheet bundle.

Incidentally, in the description of FIG. 5, the determination of whether or not to execute the air blowing operation at the start of the job based on the detecting result of the sheet presence/absence sensor 506 is described, however, the same control may be executed in a case in which the sheet presence/absence sensor 506 detects the absence of the sheet during execution of the job. In other words, assuming a case in which during the execution of the job, the sheet presence/absence sensor 506 detects the absence of the sheet and the job is interrupted, and then by the user replenishing the sheet S, the sheet presence/absence sensor 506 detects the presence of the sheet. In this case, even if the predetermined time τ has not elapsed since the completion of the last blowing operation, the control portion 100 resumes the feeding operation after executing the air blowing operation.

In addition, the method for executing the air blowing operation in the case in which the replenishment (exchange) of the sheet may be performed is not limited to the method using the detecting result of the sheet presence/absence sensor 506. For example, in a case in which the image forming apparatus 201 is in a sleep mode between the completion of the last job and the input of the current job, then it may be configured that the control portion 100 determines that the replenishment (exchange) of the sheet S may have been performed and execute the air blowing operation at the start of the current job. Similarly, for example, in a case in which between the completion of the last job and the input of the current job, an opening/closing detecting sensor, which is provided to the storage 510, detects opening/closing of the storage 510, the control portion 100 may determine that the replenishment (exchange) of the sheet S may have been performed.

### Setting Example of the Predetermined Time τ

In the present Embodiment, the value for the predetermined time τ, which defines the time interval of the air blowing operation, is set to different values depending on the environment conditions at the start of the print job and the sheet information about the sheet S used for the print job.

By selecting the value of the predetermined time τ from a plurality of the values, it becomes possible to achieve both of the suppression of the separation defect of the sheet S and the improvement of the productivity. In other words, compared to a case in which the predetermined time τ is always set to the same value (a value with which the separation defect of the sheet S can be suppressed regardless of conditions), the value of the predetermined time τ may be increased under a condition in which the increase of the adsorption force between the sheets is relatively slow, and it becomes possible to reduce a frequency of the air blowing operations. By this, it becomes possible to improve the productivity of the optional feeding device 500 (the number of sheets fed with respect to the elapsed time from the start of the print job). In addition, it becomes possible to improve productivity of the image forming apparatus 201 (an output number of sheets of images with respect to the elapsed time from the start of the print job). Hereinafter, setting examples of the predetermined time τ will be described.

First, a setting example of the predetermined time τ depending on the environment conditions will be described. As described above, in the present Embodiment, the operating condition for the air blowing operation is changed depending on the environment condition. This is because the maximum value of the adsorption force between the sheets varies depending on the environment condition, even in a case of the same type of the sheet S. Similarly, the transition of the adsorption force corresponding to the elapsed time after the adsorption force between the sheets is reduced by the air blowing operation also varies depending on the environment condition. Therefore, in each of the “high temperature and high humidity environment” and the “normal environment”, which are subject to the air blowing operation, the transition of the adsorption force between the sheets corresponding to the elapsed time after the air blowing operation is examined, and appropriate values for the predetermined time τ are determined in advance. As an example, the values for the predetermined time τ for each environment classification for the coated paper (a coated paper 1 below) are determined as follows.

TABLE 2

| Environment classifications | Predetermined time τ |
|---|---|
| High temperature and high humidity | 30 seconds |
| environment | |
| Normal environment | 240 seconds |

According to the example above, the execution interval between the air blowing operations in the high temperature and high humidity environment is shorter than the execution interval between the air blowing operations in the normal environment. In other words, the predetermined time τ (30 sec) in a case in which the absolute moisture content is a first content (for example, a content corresponding to 30° C./80% RH) is shorter than the predetermined time τ (240 sec) in a case in which the absolute moisture content is a second content (for example, a content corresponding to 23° C./50% RH) less than the first content.

By this, by executing the air blowing operations at a high frequency in the high temperature and high humidity environment in which the adsorption force between the sheets increases relatively quickly, it becomes possible to suppress the separation defect of the sheet S. In addition, by executing the air blowing operations at a low frequency in the normal environment in which the adsorption force between the sheets increases relatively slowly, it becomes possible to improve the productivity of the optional feeding device 500.

Next, a setting example for the predetermined time τ depending on the type of the sheet S will be described. In the present Embodiment, the coated papers are classified into the following three types according to the basis weight thereof, and the values for the predetermined time τ are set for each type. The control portion 100 selects an appropriate value for the predetermined time τ based on the type of the sheet S used in the print job.

TABLE 3

| | | | Predetermined |
|---|---|---|---|
| | | Predetermined | time τ |
| | | time τ | (High temperature |
| Sheet | Basis weight range | (Normal | and high humidity |
| classifications | g/m² | environment) | environment) |
| Coated paper 1 | 106 through 163 | 240 seconds | 30 seconds |
| Coated paper 2 | 164 through 220 | 230 seconds | 25 seconds |
| Coated paper 3 | 221 through 256 | 220 seconds | 20 seconds |

A ease of the increase of the adsorption force between the sheets depends on physical property values of the sheet S. The physical property values of the sheet S include, for example, permeability (ease of permeation of air), smoothness (smoothness of a surface), and stiffness (ease of deformation). Therefore, it is preferable to examine the ease of the increase of the adsorption force for each type of the sheet S and determine the values for the predetermined time τ in advance.

According to the above example, the execution interval between the air blowing operations in a case in which the “coated paper 3” having a large basis weight is used is shorter than the execution interval between the air blowing operations in a case in which the “coated paper 1” having a small basis weight is used. In other words, the predetermined time τ (220 seconds or 20 seconds) in a case in which the basis weight is a first value (e.g., 240 g/m²) is shorter than the predetermined time τ (240 seconds) in a case in which the basis weight is a second value (e.g., 120 g/m²) smaller than the first value.

By this, by executing the air blowing operations at a high frequency in the case in which the “coated paper 3”, in which it is easier for the adsorption force between the sheets to increase, is used, it becomes possible to suppress the separation defect of the sheet S. In addition, by executing the air blowing operations at a low frequency in the case in which the “coated paper 1”, in which it is relatively not easier for the adsorption force between the sheets to increase, is used, it becomes possible to improve the productivity of the optional feeding device 500.

In addition, the adsorption force between the sheets is also affected by a sheet size, and the larger the sheet size, the easier for the adsorption force between the sheets to increase. Therefore, as the sheet size gets larger, it is preferable to shorten the predetermined time τ. In other words, the predetermined time τ in a case in which the sheet S having a first size (e.g., A3 size) is used is shorter than the predetermined time τ in a case in which a second size (e.g., B4 size) smaller in area than the first size is used.

By this, by executing the air blowing operations at a high frequency in the case in which the sheet S having the first size, in which it is easier for the adsorption force between the sheets to increase, is used, it becomes possible to suppress the separation defect of the sheet S. In addition, by executing the air blowing operations at a low frequency in the case in which the sheet S having the second size, in which it is relatively not easier for the adsorption force between the sheets to increase, is used, it becomes possible to improve the productivity of the optional feeding device 500.

Incidentally, it is also desirable to change the operating condition for the air blowing operation depending on the sheet classification and the sheet size. For example, in the case in which the “coated paper 3” is used, compared to the case in which the “coated paper 1” is used, it may be considered that the fun rotation number is increased and the blowing time is lengthened. In addition, in the case in which the sheet S having the first size is used, compared to the case in which the sheet S having the second size is used, it may be considered that the fan rotation number is increased and the blowing time is lengthened. By this, with the single air blowing operation, it becomes possible to reduce the adsorption force between the sheets more surely.

### Modified Example

In the Embodiment described above, the optional feeding device 500 is

described as an example of the sheet feeding device. However, the present technology is not limited thereto, but may be applied to any sheet feeding device provided with the air blowing portion (air loosening mechanism), for example, any of the cassette feeding portion 230 or the manual feeding portion 235. In addition, it is not limited to the sheet feeding device which feeds the sheet S as the recording medium toward the image forming portion 201B. For example, the present technology may be applied to a sheet feeding device which feeds the sheet S as an original in the image reading apparatus, or a sheet feeding device which feeds the sheet S subject to be sorted in a sheet type sorting device.

The feeding mechanism constituted by the pickup roller 501, the feed roller 502 and the retard roller 503, which is described in the Embodiment described above, is an example of the feeding unit 500F, which feeds the sheets S one by one. For example, a feeding unit of belt conveyance type, which suctions the single sheet S on a feeding belt by negative pressure generated by a fan and conveys the sheet S, may be used. In addition, the retard roller 503 is an example of a separating member which performs the separation of the sheet S, and for example, an elastic member having a pad shape, which is in contact with the feed roller 502, may be used as the separating member.

In addition, in the Embodiment described above, the method using the values for the predetermined time τ, which are set in advance depending on the environment condition and the sheet information, is exemplified. However, not limited to this, for example, it may be configured that a user can arbitrarily set the value for the predetermined time τ via the operating portion 730.

In addition, in the Embodiment described above, the value for the predetermined time τ is determined based on the environment condition at the start of the print job, and the value for the predetermined time τ is not changed for that print job. However, not limited to this, for example, in a case in which the elapsed time T from the last air blowing operation exceeds the predetermined time τ, the environment condition is determined again based on the detecting result of the environment sensor 522, and the value for the predetermined time τ may be updated. In other words, in the flow in FIG. 5, it may be configured that the process may be returned to S2 in the case of No in S7. The present Modified Example may be advantageous in a case in which the print job is executed for a long period of time, or in a case in which the image forming apparatus 201 is installed in a place where change in the environment condition is significant.

### Other Embodiments

The present invention may also be realized by a process in which a program realizing one or more functions of the Embodiments described above are supplied to the system or the apparatus via a network or a storage medium, and one or more processors in a computer of the system or the apparatus read out and execute the program. In addition, the present invention may also be realized by a circuit which realizes the one or more functions (e.g., ASIC).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-064666, filed on Apr. 12, 2024, which is hereby incorporated by reference herein in its entirety.

What is claimed is:

1. A sheet feeding device comprising:
a supporting portion configured to support a sheet bundle;
a feeding means configured to separate and feed a sheet one by one from the sheet bundle;
an air blowing portion configured to blow air to a side end of the sheet bundle;
a control means configured to execute a blowing operation in which the air is blown to the side end of the sheet by the air blowing portion and a feeding operation in which the sheet is fed by the feeding means,
wherein after execution of the blowing operation. the control means executes the feeding operation in a state of stopping the blowing operation in a case in which a predetermined time has not elapsed from completion of the blowing operation, and executes another blowing operation and executes the feeding operation in a state of stopping the another blowing operation in a case in which the predetermined time has elapsed from the completion of the blowing operation.

2. The sheet feeding device according to claim 1, further comprising an environment sensor configured to detect an environment condition around the sheet feeding device,
wherein the control means changes the predetermined time depending on the environment condition based on a detecting result of the environment sensor.

3. The sheet feeding device according to claim 2, wherein the control means changes the predetermined time so that the predetermined time in a case in which an absolute moisture content in air around the sheet feeding device is a first content is shorter than the predetermined time in a case in which the absolute moisture content is a second content less than the first content.

4. The sheet feeding device according to claim 1, wherein the control means changes the predetermined time depending on a basis weight of the sheet supported by the supporting portion.

5. The sheet feeding device according to claim 4, wherein the control means changes the predetermined time so that the predetermined time in a case in which the basis weight is a first value is shorter than the predetermined time in a case in which the basis weight is a second value smaller than the first value.

6. The sheet feeding device according to claim 1, wherein the control means changes the predetermined time depending on a sheet size of the sheet supported by the supporting portion.

7. The sheet feeding device according to claim 6, wherein the control means changes the predetermined time so that the predetermined time in a case in which the sheet size is a first size is shorter than the predetermined time in a case in which the sheet size is a second size smaller in area than the first size.

8. The sheet feeding device according to claim 1, further comprising an operating portion configured to accept an operation from a user,
wherein the control means determines the predetermined time based on an input to the operating portion from the user.

9. The sheet feeding device according to claim 1, wherein in a case in which after a first job in which a sheet is fed, a second job in which a sheet is fed is executed, when an elapsed time from the completion of a last blowing operation which has been executed during execution of the first job until start of the second job does not exceed the predetermined time, the control means starts the feeding operation without executing the blowing operation at the start of the second job.

10. The sheet feeding device according to claim 1, further comprising a sheet detecting means configured to detect presence or absence of the sheet in the supporting portion,
wherein in a case in which the sheet detecting means detects the presence of the sheet in the supporting portion after the sheet detecting means has detected the absence of the sheet in the supporting portion, the control means starts the feeding operation after executing the blowing operation even if the predetermined time has not elapsed from the completion of a last blowing operation.

11. The sheet feeding device according to claim 1, wherein in a case in which a job in which a number of sheets designated are fed is interrupted and then the job is resumed, when an elapsed time from completion of a last blowing operation which has been executed before interruption of the job until the resumption of the job exceeds the predetermined time, the control means starts the feeding operation after executing the blowing operation irrespective of the number of sheets fed by the feeding means until the interruption of the job.

12. The sheet feeding device according to claim 1, wherein in a case in which a job in which a number of sheets designated are fed is executed, the control means repeats the feeding operation from completion of a last blowing operation until the predetermined time elapses, and when the predetermined time has elapsed from the completion of the last blowing operation, the control means repeatedly stops the feeding operation and executes another blowing operation until completion of feeding the number of sheets designated.

13. The sheet feeding device according to claim 1, wherein the feeding means includes a first roller configured to contact the uppermost sheet and feed the sheet from the supporting portion in a sheet feeding direction, a second roller disposed downstream of the first roller in the sheet feeding direction and configured to feed the sheet in the sheet feeding direction, and a third roller configured to form a separating nip by contacting the second roller and configured to apply a friction force to the sheet passing through the separating nip in a direction opposite to the sheet feeding direction, and
wherein the air blowing portion includes a fan configured to generate an air flow and a nozzle configured to blow the air flow toward an end portion of the sheet bundle in a sheet widthwise direction perpendicular to the sheet feeding direction.

14. An image forming apparatus comprising:
a sheet feeding device according to claim 1; and
an image forming means configured to form an image on a sheet fed by the sheet feeding device.

15. The image forming apparatus according to claim 14, wherein the supporting portion of the sheet feeding device is movably provided to the image forming apparatus, and
wherein the supporting portion is movable to an opening position opening to the image forming apparatus when the sheet is placed on and fed and to a closed position closed to the image forming apparatus when the sheet is not placed on.
